(19) United States
(12) Patent Application Publication
(10) Pub. No.: US 2025/0026677 A1
(43) Pub. Date: Jan. 23, 2025

(54) COLOURLESS SODA-LIME GLASS COMPOSITION

(71) Applicant: ARC FRANCE, Arques (FR)

(72) Inventors: Hervé CHARLES, Arques (FR); Rodolphe DELAVAL, Arques (FR); Xavier IBLED, Arques (FR)

(73) Assignee: ARC FRANCE, Arques (FR)

(21) Appl. No.: 18/707,316

(22) PCT Filed: Nov. 3, 2022
(86) PCT No.: PCT/EP2022/080738

§ 371 Date: May 3, 2024

(30) Foreign Application Priority Data
Nov. 4, 2021 (FR) FR2111730

(51) Int. Cl. C03C 3/087

(52) U.S. Cl. CPC C03C 3/087; C03C 2201/10; C03C 2201/20; C03C 2201/36; C03C 2201/40; C03C 2201/50; C03C 2201/54

(57) ABSTRACT

A colorless soda-lime glass composition comprising by weight from 68 to 78% SiO₂, from 8 to 18% Na₂O, from 0 to 10% K₂O, from 7 to 12% CaO, from 0 to 10% MgO, from 0 to 10% ZnO, from 0 to 10% BaO, from 0 to 3% Al₂O₃, from 0 to 1% B₂O₃, from 0 to 1% SrO, less than 0.078% total sulfur expressed in the form of SO₃, at most 0.12% total cerium expressed in the form of CeO₂, from 50 to 1200 ppm total iron expressed in the form of Fe₂O₃, without the intentional addition of Mo, As, Sn and Sb species, and with a redox lower than 45.

The invention relates to the field of glass industry. Melting the constituent materials of glass requires the supply of a large amount of energy. The temperature of the glass bath is in the range of 1,300 to 1,500° C. Depending on its composition, the glass is intended for household use, for example drinking glasses, or for culinary use, for example cooking vessels.

The furnace is subjected to very high thermal and mechanical stresses. The furnace is built with high-quality refractory coatings. These refractory coatings are expensive and sensitive to some constituents of the glass prone to chemical reaction. The refractory coatings being poor heat conductors, heating of the glass bath is performed by the interior of the furnace, for example from above or in the molten glass bath.

For example, there is a flame burner with a liquid or gaseous fuel between the glass bath and the top of the furnace so-called the vault. The glass bath is heated essentially by radiation. The outlet temperature of the gases is from 1,300 to 1,600° C. depending on the glass family.

Moreover, glass manufacture releases large amounts of gas. The glass bath is degassed for several hours to avoid the formation of bubbles in the glass. To facilitate degassing, refining additives such as sulphates may be used. The furnace operates in a continuous batch of glass with a selected composition which could vary throughout the batch.

The Applicant has observed that the sulphates might have drawbacks in terms of pollution, in particular in the outlet gases or the glass bath.

The Applicant has proceeded with tests of reduction of the amount of sulphates introduced into the bath without increasing the refining duration and while preserving the quality of the glass.

The invention proposes a colourless soda-lime glass composition, comprising, by weight, from 68 to 78% SiO₂, from 8 to 18% Na₂O, from 0 to 10% K₂O, from 7 to 12% CaO, from 0 to 10% MgO, from 0 to 10% ZnO, from 0 to 10% BaO, from 0 to 3% Al₂O₃, from 0 to 1% B₂O₃, from 0 to 1% SrO, less than 0.078% total sulphur expressed in the form of SO₃, at most 0.12% total cerium expressed in the form of CeO₂, from 50 to 1,200 ppm total iron expressed in the form of Fe₂O₃, without any intentional addition of the Mo, As, Sn and Sb species, and with a redox lower than 45.

An SiO₂ content lower than 68% reduces the viscosity of the glass and increases the coefficient of expansion.

An SiO₂ content higher than 78% makes melting more difficult.

An Na₂O content lower than 8% reduces the melting kinetics.

An Na₂O content higher than 18% increases the wear of the refractories of the furnace and increases the coefficient of expansion.

Beyond a K₂O content of 10%, the viscosity of the glass bath substantially increases.

A CaO content lower than 7% reduces the slope of the temperature viscosity curve and slows down the glass forming rate on the shaping machines.

A CaO content higher than 12% leads to a risk of devitrification by crystallisation.

An MgO content higher than 10% reduces the softening point of the glass.

A ZnO content higher than 10% reduces the softening point of the glass and increases the density of the glass.

A BaO content higher than 10% reduces the softening point of the glass and increases the density of the glass.

An Al₂O₃ content higher than 3% increases the melting temperature.

A B₂O₃ content higher than 1% increases the corrosion of the refractories and evaporates with downstream deposits.

A total cerium content expressed in the form of CeO₂ higher than 0.12% causes a colouration of the glass by metamerism.

A total iron content expressed in the form of Fe₂O₃ lower than 50 ppm makes the selection of the raw materials more difficult, a low iron content generally being not available for the silicon, calcium and sodium addition sources, and limits the recycling of the cullet. The glass bath becomes transparent to infrared thereby an increase in the temperature in the proximity of the hearth and of the walls of the furnace and an accelerated wear of the refractories.

A total content of iron expressed in the form of Fe₂O₃ higher than 1,200 ppm causes a colouration that is difficult to fight, in particular without the addition of an oxidant to oxidise FeO into Fe₂O₃ which is less coloured.

An intentional addition of As is not desirable for reasons related to toxicity.

An intentional addition of Sb is not desirable for reasons related to toxicity.

The Applicant has noticed that the redox corresponding to the ferrous iron/ferric iron ratio was important for a successful refining at low sulphate contents. The redox has an influence on the solubility of SO₃. The minimum solubility is found at a redox close to 55.

The redox is herein defined as the FeO (ferrous)/Fe₂O₃ (ferric) molar ratio.

The Applicant has discovered that, in an air and natural gas combustion furnace, for a redox of 40, the mass content of SO₃ of the glass had a maximum of about 0.20%. In other words, a degasification of sulphates occurs in case of a higher content in the glass bath. On the other hand, obtaining a lower mass content of SO₃ in the glass is difficult under identical production conditions. Indeed, by increasing the refining duration, it is possible to reduce the amount of refining agent but at the price of a decrease in the production proportional to the inverse of the refining duration and an increase in the energy consumption and the wear of the furnace by tone of produced glass.

In an oxygen and natural gas combustion furnace, for a redox of 40, the mass content of SO₃ in the glass had a maximum of about 0.10%. The redox could be reduced to a value ranging from 10 to 15.

Yet, refining a very oxidised glass results in an increase in the refining duration and a low tonnage produced. Thus, for reasons related to the speed of refining and discolouration of the glass to obtain a so-called white glass, i.e. transparent and substantially colourless, a redox of at least 18, or at least 25, is preferred. In this redox range, the more oxidised the glass, the higher the maximum relative amount of sulphate remaining in the glass will be.

A redox range comprised between 20 and 45 is preferred. A redox range comprised between 25 and 40 is more preferred. A redox of 30 to 40 is even better.

In one embodiment, the composition comprises, by weight, less total sulphur expressed in the form of SO₃ than the maximum allowed by the redox and the composition of the glass.

In one embodiment, the composition comprises, by weight, less than 0.074% total sulphur expressed in the form of SO₃. The condensation is reduced. The reactivity of the glass with the components of the production line is reduced.

In one embodiment, the composition comprises, by weight, from 0 to 1% TiO₂.

In one embodiment, the composition comprises, by weight, from 0 to 0.3% F. Beyond 0.3%, the corrosion of the moulds is increased.

In one embodiment, the composition comprises, by weight, from 71.0 to 73.0% SiO₂, from more than 8 to less than 15% Na₂O, from 0 to 0.5% K₂O, from 9 to less than 12% CaO, from 1 to 2% MgO, from 0 to 1% ZnO, from 0 to 2% BaO, from 0 to 2% Al₂O₃, at most 0, 1% total cerium expressed in the form of CeO₂, less than 0.10% ZrO2, less than 200 ppm Er₂O₃, and with a redox lower than 40.

In a preferred embodiment, the composition comprises, by weight, 13.0 to 14.0% Na₂O.

In a preferred embodiment, the composition comprises, by weight, from 0 to 0.2% K₂O.

In a preferred embodiment, the composition comprises, by weight, from 10.0 to 11.4% CaO.

In a preferred embodiment, the composition comprises, by weight, less than 0.10% BaO.

In a preferred embodiment, the composition comprises, by weight, from 1.0 to 1.90% Al₂O₃. Below 1% Al₂O₃, the finished glass has a lower chemical resistance.

In a preferred embodiment, the composition comprises, by weight, less than 0.05% ZrO2.

In a preferred embodiment, the composition comprises, by weight, less than 150 ppm Er₂O₃. The discolouration could be obtained by Selenium, for example in the form of zinc selenite ZnSeO₃ CAS 13597₋₄₆₋₁.

In one embodiment, the composition does not involve an intentional addition of any Ti species.

In one embodiment, the composition does not involve an intentional addition of any B species.

In one embodiment, the composition does not involve an intentional addition of any Zn species.

In one embodiment, the composition does not involve an intentional addition of any Sr species.

In one embodiment, the composition does not involve an intentional addition of any Sn species.

In one embodiment, the composition does not involve an intentional addition of any Ce species.

In one embodiment, the composition does not involve an intentional addition of any Cr species.

In one embodiment, the composition comprises, by weight, from 0 to 0.06%, preferably from 0 to 0.05%, BaO. The optical properties are obtained by other chemical species.

In one embodiment, the composition comprises, by weight, from 100 to 300 ppm total iron expressed in the form of Fe₂O₃.

In a preferred embodiment, the composition comprises, by weight, from 100 to 250 ppm total iron expressed in the form of Fe₂O₃.

In one embodiment, the composition comprises, by weight, more than 300 to 900 ppm total iron expressed in the form of Fe₂O₃.

In a preferred embodiment, the composition comprises, by weight, from 300 to less than 700 ppm total iron expressed in the form of Fe₂O₃.

In one embodiment, the composition is intended for household or culinary use.

In one embodiment, the composition comprises a lightness value L* according to CIE1976 in total transmission higher than 94, preferably higher than 95. These values correspond to a transparent glass also so-called white glass.

In one embodiment, the redox is at least 18.

In one embodiment, the redox is at least 20.

In one embodiment, the composition comprises, by weight, from 69.0 to 75.0% SiO₂, from 12.0 to 16.0% Na₂O+K₂O, from 10.0 to 15.5% CaO+MgO+BaO, from 0.5 to 3.0% Al₂O₃, and from 0 to 1.0% B₂O₃.

In general, the mixture of raw materials should be understood as glass raw materials.

Other features and advantages of the invention will become apparent upon examining the detailed description hereinafter.

The refining of the glass is a very important step in glass production. This step is described in various structures, the refining agents and their behaviour being detailed in the context of a furnace conventional operation.
1. Le Verre—Sciences et Technologie—James BARTON and Claude GUILLEMET.
2. Glass Science (Second edition)—Robert H. DOREMUS (Rensselaer Polytechnic Institute)—Wiley-Interscience publication John Wiley & Sons Inc.
3. Glass—Science and Technology—Volume 2 Processing I—Edited by D. R. UHLMANN and N. J. KREIDL.
4. Elaboration du verre (fusion et affinage)—Etude bibliographique—Symposium de l'Union Scientifique Continentale du verre (Belgium)—Madrid, 11-14 Sep. 1973.

On the other hand, these structures do not allow revealing approaches for reducing sulphates. It is generally accepted that the residual sulphate content in the glass is strongly related to the redox state of the produced glass. Thus, without modification of the Redox, there cannot be any reduction in the concentration of SO₃ in the finished glass; and such a reduction would be vain because the SO₃ content is a guarantee for the quality of the produced items, in particular the refining of the final glass.

The soda-lime glass is refined by adding sulphates. A particular attention is given to the following points: glass working temperature, glass working level, corrosion of the refractories, temperatures in the fume extraction circuit and the filtration system, filtration temperatures higher than the dew point of hydrochloric acid, quality of the filtration on the existing filtration equipment, potential impact on the corrosion of the steel moulds used for the production of glassware items.

Platinum coatings are often used in glassware to avoid the phenomena of enrichment of the glass by various pollutions, which are at the origin of creation of heterogeneous glass. For example, in the field of table arts, this enrichment could be revealed in the dishwasher by apparition of fine yarns, in the form of a wig. These yarns are specific to a localised enrichment of zirconia, a chemical compound present in the refractories used for the construction of the furnaces and the feeders, i.e. the flow channels of glass towards the shaping machines. Platinum, which is a neutral element with respect to the glass, allows avoiding this glass/refractory interface detrimental to the quality of the glass.

The platinum may also serve as a protective coating for metals subject to sublimation at the temperatures of use in the glass or structural material process, cf. WO2016135084.

The Applicant estimates that lowering the residual sulphate in the glass could allow reducing the use of platinum.

The Applicant has conducted several production tests by testing several compositions. These tests have been conducted with the same raw materials, the amounts of which have been adjusted to obtain the desired final composition.

The use of toxic components, like arsenate, or with the risk of pollution, like nitrate, has been avoided. In order to promote refining despite the reduction of sulphates, an addition of halogens has been considered. Yet, their presence in a soda-lime glass has risks. Thus, the chlorine has a problem of solubility in soda-lime glass thereby a substantial dose to be considered in order to obtain an effect on refining.

The discolouration of the glass can be performed with zinc selenite for a redox from 20 to 45.

In a test of a first industrial furnace over more than 15 days, the daily production has varied from −17% to +18% relative to the average. The ZrO2 content is comprised between 335 and 961 ppm. The CaO content is comprised between 9.03 and 11.36%. The MgO content is comprised between 1.13 and 1.51%. The K₂O content is comprised between 0.04 and 0.36%. The SiO₂ content is comprised between 71.48 and 72.74%. The Al₂O₃ content is comprised between 1.39 and 3.01%. The Na₂O content is comprised between 13.03 and 14.37%. The CeO₂ content is comprised between 827 and 1,007 ppm. The redox is comprised between 18 and 36 with an average equal to 26. The luminance L* is comprised between 94.35 and 95.75, with an average equal to 95.38. The glass is of commercial grade with a significant refining duration without change. This results in a correct refining. In particular, the average total refining over the retained period is lower than 0.7 glass broth/cm³ visible to the binocular magnifier at 20× magnification and lower than 0.55 broth at more than 100 μm per cm³. The daily production is stable.

Se, Co, Er additions have been performed with a positive effect on individual addition discolouration. The preferred mode is an addition of the three species Se, Co and Er in the form of an oxide. The amount of zinc selenite may be comprised between 0.5 and 5 ppm. The amount of CoO may be comprised between 0.5 and 5 ppm. The amount of Er₂O₃ may be comprised between 50 and 200 ppm. The total amount of zinc selenite, CoO and Er₂O₃, may be comprised between 50 and 200 ppm.

There is no intentional introduction of the Zn, Ba, B, Sr, Mo, As, Sn, Sb, Ti and F species.

Table 1 below contains glass composition data measured at the production output during production tests on an industrial furnace conducted over a sufficient period of time for a change in the composition of the raw materials to be reflected in a stable manner in the composition of the produced glass. Moreover, the measurements No. 1 to 12 are spaced apart by several hours for a regular monitoring of the production. The CaO, K₂O, SiO₂, Al₂O₃, MgO, Na₂O, CeO₂, Er₂O₃, ZnSeO₃ and CoO contents originate from the introduced raw materials. In this configuration, these species have proved to be not very subject to evaporation in the furnace. Their contents are well controlled to the extent that the composition of the introduced raw materials is constant over time.

The ZrO2 content depends on the operating conditions of the furnace and of the channels downstream as zirconia in the glass originates from the refractories forming the vessel of the furnace and the channels. The zirconia is absent from the raw materials. The presence of zirconia reflects the wear of the furnace and of the channels. A high zirconia content indicates a short service life of the furnace between two replacements of refractories and a high cost price of the produced glass tonne. The zirconia content is in particular sensitive to the temperature of the glass bath and to the operating incidents, for example a modification of the movements within the glass bath.

The iron oxide total content depends on the quality and the consistency of the introduced raw materials. Hence, this parameter is difficult to control. The redox depends on the degree of oxidation of the glass and is correlated with the colour of the glass in the absence of colourants. At an identical redox, the colour of the glass may be modified by colouring materials.

The SO₃ content depends on the amount of sulphates introduced into the glass bath, the redox, the heating mode and constructive parameters of the furnace. The Applicant has sought to produce a soda-lime glass for household or culinary use that is transparent and has a low SO₃ content. The daily production of the furnace is equal or close to that of the same furnace with a higher sulphate content, which was not expected.

In general, the composition measurements may be performed according to the standard ASTM C169.

The measurement of the sulphates content is performed by X-ray fluorescence according to DIN 51001. For a higher accuracy, a method can be performed by HF and then HNO₃ acid digestion, followed by an analysis using an ICP spectrometer which has shown a reduced dispersion of 35%.

TABLE 1

| | ZrO2 | CaO | K2O | SO3 | SiO2 | Al2O3 | MgO | Na2O | CeO2 | Er2O3 | FeO | Fe2O3 | Fe tot | redox | Se | CoO | |
|---|---|---|---|---|---|---|---|---|---|---|---|---|---|---|---|---|---|
| Date | PPM | % | % | PPM | % | % | % | % | PPM | PPM | PPM | PPM | PPM | % | PPM | PPM | L* |
| 1 | 776 | 9.4 | 0.36 | 423 | 71.5 | 3.01 | 1.13 | 13.0 | 998 | 173 | 38 | 206 | 248 | 18.4 | 1.55 | 0.87 | 95.61 |
| 2 | 366 | 9.0 | 0.23 | 421 | 72.4 | 2.36 | 1.19 | 13.4 | 1,007 | 208 | 40 | 175 | 219 | 22.9 | 2.40 | 0.90 | 95.16 |
| 3 | 829 | 11.4 | 0.08 | 429 | 72.1 | 1.66 | 1.46 | 13.4 | 938 | 219 | 44 | 153 | 202 | 28.8 | 2.08 | 0.96 | 95.15 |
| 4 | 644 | 10.0 | 0.07 | 639 | 72.7 | 1.62 | 1.34 | 13.6 | 981 | 164 | 33 | 165 | 193 | 21.2 | 1.94 | 0.84 | 95.48 |
| 5 | 709 | 10.2 | 0.07 | 633 | 72.6 | 1.64 | 1.36 | 13.6 | 967 | 181 | 35 | 155 | 194 | 22.6 | 1.85 | 1.14 | 94.35 |
| 6 | 890 | 11.1 | 0.11 | 405 | 72.1 | 1.76 | 1.44 | 13.3 | 950 | 216 | 41 | 160 | 206 | 25.6 | 1.99 | 0.95 | 95.25 |
| 7 | 872 | 10.7 | 0.05 | 707 | 72.4 | 1.54 | 1.46 | 13.6 | 925 | 89 | 41 | 160 | 206 | 25.6 | 0.91 | 0.76 | 95.75 |
| 8 | 784 | 10.9 | 0.05 | 699 | 72.3 | 1.54 | 1.51 | 13.6 | 926 | 94 | 40 | 162 | 206 | 24.7 | 0.75 | 0.81 | 95.71 |
| 9 | 961 | 10.9 | 0.05 | 675 | 72.3 | 1.56 | 1.49 | 13.6 | 921 | 96 | 50 | 154 | 209 | 32.5 | 0.89 | 0.89 | 95.50 |
| 10 | 383 | 10.2 | 0.04 | 726 | 72.4 | 1.40 | 1.45 | 14.4 | 835 | 82 | 51 | 173 | 230 | 29.5 | 0.90 | 0.90 | 95.48 |
| 11 | 335 | 10.2 | 0.04 | 731 | 72.3 | 1.39 | 1.45 | 14.3 | 827 | 86 | 58 | 162 | 226 | 35.8 | 0.83 | 1.08 | 95.42 |
| 12 | 938 | 10.9 | 0.05 | 691 | 72.2 | 1.53 | 1.51 | 13.7 | 894 | 85 | 50 | 178 | 233 | 28.1 | 0.65 | 0.95 | 95.72 |
| Min | 335 | 9.0 | 0.04 | 421 | 71.5 | 1.39 | 1.13 | 13.0 | 827 | 82 | 53 | 153 | 193 | 18.4 | 0.65 | 0.84 | 94.35 |
| Max | 961 | 11.4 | 0.36 | 731 | 72.7 | 3.01 | 1.51 | 14.4 | 1,007 | 219 | 58 | 206 | 248 | 35.8 | 2.40 | 1.14 | 95.72 |

In a test of a second industrial furnace, the daily production has varied from −5% to +10% relative to the average. The ZrO₂ content is comprised between 102 and 136 ppm. The CaO content is comprised between 10.83 and 11.23%. The MgO content is comprised between 1.38 and 1.42%. The K₂O content is comprised between 0.03 and 0.04%. The SiO₂ content is comprised between 72.60 and 72.77%. The Al₂O₃ content is comprised between 1.50 and 1.52%. The Nao content is comprised between 13.31 and 13.36%. The CeO₂ content is comprised between 337 and 362 ppm. The redox is comprised between 33 and 43 with an average equal to 37. The glass is of commercial grade with a significant refining duration without change. This results in a correct refining. In particular, the average total refining over the retained period amounts to 0 glass broth/cm³ visible to the binocular magnifier at 20× magnification. The daily production is very stable.

Se, Co, Er additions have been performed with a positive effect on individual addition discolouration. The preferred mode is an addition of the three species Se, Co and Er in the form of an oxide. The amount of zinc selenite may be comprised between 0.5 and 5 ppm. The amount of CoO may be comprised between 0.5 and 5 ppm. According to the introduced raw materials, the amount of Er₂O₃ may be comprised between 50 and 200 ppm. The total amount of zinc selenite, CoO and Er₂O₃, may be comprised between 50 and 200 ppm.

There is no intentional introduction of the Zn, Ba, B, Sr, Mo, As, Sn, Sb, Ti and F species.

Table 2 below contains glass composition data measured at the production output during production tests on an industrial furnace conducted for a sufficient period of time for a change in the composition of the raw materials to be reflected in a stable manner in the composition of the produced glass. Moreover, the measurements No. 1 to 4 are spaced apart by at least 24 hours for a regular monitoring of the production. The CaO, K₂O, SiO₂, Al₂O₃, MgO, Na₂O, CeO₂, Er₂O₃ and CoO contents originate from the introduced raw materials. In this configuration, these species have proved to be not very subject to evaporation in the furnace. Their contents are well controlled to the extent that the composition of the introduced raw materials is constant over time.

Zirconia is absent from the raw materials.

The total content of iron oxides depends on the quality and on the consistency of the introduced raw materials.

The SO₃ content depends on the amount of sulphates introduced into the glass bath, the redox, the heating mode and the constructive parameters of the furnace. The Applicant has sought to produce a soda-lime glass for household or culinary use that is transparent and has a low SO₃ content. The daily production of the furnace is equal or close to that of the same furnace with a higher sulphate content, which was not expected.

TABLE 2

| | ZrO2 | CaO | K2O | SO3 | SiO2 | Al2O3 | MgO | Na2O | CeO2 | FeO | Fe2O3 | Fe tot | redox | Se | CoO | |
|---|---|---|---|---|---|---|---|---|---|---|---|---|---|---|---|---|
| Date | PPM | % | % | PPM | % | % | % | % | PPM | PPM | PPM | PPM | 33.4 | PPM | PPM | L* |
| 1 | 102 | 10.98 | 0.03 | 0.07 | 72.77 | 1.52 | 1.42 | 13.33 | 337 | 50 | 150 | 205.0 | 34.4 | 0.98 | 0.83 | 95.57 |
| 2 | 107 | 11.23 | 0.03 | 0.07 | 72.60 | 1.51 | 1.41 | 13.32 | 344 | 51 | 148 | 204.0 | 36.2 | 0.82 | 0.83 | 95.58 |
| 3 | 133 | 11.12 | 0.03 | 0.07 | 72.61 | 1.52 | 1.41 | 13.36 | 362 | 56 | 138 | 200.0 | 43.2 | 0.99 | 0.91 | 95.58 |
| 4 | 136 | 10.83 | 0.04 | 0.07 | 72.69 | 1.50 | 1.38 | 13.31 | 340 | 69 | 159 | 236.0 | 43.2 | 0.89 | 1.16 | 95.36 |
| Min | 136 | 11.23 | 0.04 | 0.07 | 72.77 | 1.52 | 1.42 | 13.36 | 362 | 69 | 159 | 236.0 | 33.4 | 0.99 | 1.16 | 95.58 |
| Max | 102 | 10.83 | 0.03 | 0.07 | 72.60 | 1.50 | 1.38 | 13.31 | 337 | 50 | 138 | 200.0 | 33.4 | 0.82 | 0.83 | 95.36 |

1. A colourless soda-lime glass composition, comprising, by weight, from 68 to 78% SiO₂, from 8 to 18% Na₂O, from 0 to 10% K₂O, from 7 to 12% CaO, from 0 to 10% MgO, from 0 to 10% ZnO, from 0 to 10% BaO, from 0 to 3% Al₂O₃, from 0 to 1% B₂O₃, from 0 to 1% SrO, less than 0.078% total sulphur expressed in the form of SO₃, at most 0.12% total cerium expressed in the form of CeO₂, from 50 to 1,200 ppm total iron expressed in the form of Fe2O3, without intentional addition of the Mo, As, Sn and Sb species, and with a redox lower than 45.

2. The composition according to claim 1, comprising, by weight, less than 0.074% total sulphur expressed in the form of SO₃.

3. The composition according to claim 1, comprising, by weight, from 0 to 1% TiO₂ and from 0 to 0.3% F.

4. The composition according to claim 1, comprising, by weight, from more than 8 to less than 15% Na₂O, from 0 to 1% ZnO, from 0 to 2%, preferably less than 0.10%, BaO, from 0 to 2%, preferably from 1.0 to 1.90%, Al₂O₃, at most 0.1% total cerium expressed in the form of CeO₂, less than 0.10%, preferably less than 0.05%, ZrO₂, less than 200 ppm Er₂O₃, and with a redox lower than 40.

5. The composition according to claim 1, comprising, by weight, from 0 to 0.5%, preferably from 0 to 0.2%, K₂O and from 1 to 2% MgO.

6. The composition according to claim 1, comprising, by weight, from 71.0 to 73.0% SiO₂ and from 9 to less than 12% CaO.

7. The composition according to claim 1, comprising, by weight, from 10.0 to 11.4% CaO.

8. The composition according to claim 1, comprising, by weight, less than 150 ppm Er₂O₃.

9. The composition according to claim 1, comprising, by weight, from 13.0 to 14.0% Na₂O.

10. The composition according to claim 1, without intentional addition of the Ti, Ce, B, Zn, Sr and Sn species.

11. The composition according to claim 1, comprising, by weight, from 0 to 0.06%, preferably from 0 to 0.05%, BaO.

12. The composition according to claim 1, comprising, by weight, from 100 to 300 ppm total iron expressed in the form of Fe2O3, preferably from 100 to 250 ppm.

13. The composition according to claim 1, comprising, by weight, more than 300 to 900 ppm total iron expressed in the form of Fe₂O₃, preferably less than 700 ppm.

14. (canceled)

15. The composition according to claim 1, comprising a luminance value L* according to CIE1976 in total transmission higher than 94, preferably 95.

16. The composition according to claim 1, comprising, by weight, from 0.0405 to 0.0731% total sulphur expressed in the form of SO₃.

17. The composition according to claim 1, wherein the redox is higher than 30 and lower than 40.

18. The composition according to claim 1, comprising at least one from among Se, Co and Er, preferably the total amount of zinc selenite, CoO and Er₂O₃ is comprised between 50 and 200 ppm.

19. The composition according to claim 1, wherein the ZrO₂ content is comprised between 335 and 961 ppm, the CaO content is comprised between 9.03 and 11.36%, the MgO content is comprised between 1.13 and 1.51%, the K₂O content is comprised between 0.04 and 0.36%, the SiO₂ content is comprised between 71.48 and 72.74%, the Al₂O₃ content is comprised between 1.39 and 2%, the Na₂O content is comprised between 13.03 and 14.37%, the CeO₂ content is comprised between 827 and 1,000 ppm, the redox is comprised between 18 and 36, the luminance L* is comprised between 94.35 and 95.75.

20. The composition according to claim 1, wherein the ZrO₂ content is comprised between 102 and 136 ppm, the CaO content is comprised between 10.83 and 11.23%, the MgO content is comprised between 1.38 and 1.42%, the K₂O content is comprised between 0.03 and 0.04%, the SiO₂ content is comprised between 72.60 and 72.77%, the Al₂O₃ content is comprised between 1.50 and 1.52%, the Na₂O content is comprised between 13.31 and 13.36%, the CeO₂ content is comprised between 337 and 362 ppm, the redox is comprised between 33 and less than 40, the luminance L* is comprised between 95.36 and 95.58.

21. (canceled)

22. (canceled)

23. The composition according to claim 1, comprising, by weight, from 69.0 to 75.0% SiO₂, from 12.0 to 16.0% Na₂O+K₂O, from 10.0 to 15.5% CaO+MgO+BaO, from 0.5 to 3.0% Al₂O₃, and from 0 to 1.0% B₂O₃.
